(19) United States
(12) Patent Application Publication
(10) Pub. No.: US 2008/0161068 A1
(43) Pub. Date: Jul. 3, 2008

(54) Device, method and system for implementing an echo control on hand-free phones

(75) Inventors: Tong-Chuan Pang, Beijing (CN); Cao Xu, Beijing (CN); Xiu-Mei Zhai, Beijing (CN); Jing-Jing Meng, Beijing (CN); Xin-Yi Wang, Beijing (CN); Xin Wang, Beijing (CN)

Correspondence Address: Troxell Law Office Pllc, Suite 1404, 5205 Leesburg Pike, Falls Church, VA, 22041, US

(73) Assignee: Aplus Communication Technology (Beijing) Co., Ltd.

(21) Appl. No.: 11/896,468

(22) Filed: Aug. 31, 2007

(30) Foreign Application Priority Data
Nov. 6, 2006 (CN) 200610114324-3

(51) Int. Cl. H04B 1/38

(52) U.S. Cl. 455/570

(57) ABSTRACT

This invention provides a device, method and system for implementing an echo control on hand-free phones, including an echo eliminator as a primary component. The method in use is listed as follows.

First of all, local speech signals on a sending channel as well as remote speech signals on a receiving channel are sampled. Then call status of a current network is determined based on energy of the obtained remote and local speech signals samples. Finally, a corresponding echo control treatment to the speech signals traveling through the sending channel according to the resulting call status is given. As a result, the echo in a digital hand-free communication system can be efficiently eliminated.

### BACKGROUND OF THE INVENTION

a) Field of the Invention

The present invention relates to technology of communication, and more particularly to a device, method and system for implementing an echo control on hand-free phones.

b) Description of the Prior Art

With the rapid development of communication technology, a hand-free technology is widely used in communication products, such as a security network, a computer telephone, an audio conference, and a Personal Digital Assistant (PDA). In addition, a hand-free speech technology is also increasingly popularized in an access control system, an elevator phonetic system and a hotel parking walky-talky system.

In a typical hand-free phone application environment, if a loudspeaker plays audio signals without any processing, a microphone of the hand-free phone will collect and transmit the audio signals. This may cause an echo when one is talking to a user who uses a hand-free phone, and severely even oppressive howling, making it difficult to communicate.

In all existing technologies, devices for echo and feedback elimination in the hand-free phones are generally costly and complicated. A way to cancel echo in the hand-free phones is to implement a solution using an automatic, half duplex technology. FIG. 1 depicts the principle of the solution. The following presents the procedure in more detail.

An echo and feedback control module consists of a comparator and a logical decision module that implements functions of a hardware judgment controller. By comparing signals of a sending channel with a size of noise envelope, the echo and feedback control module determines whether the sending channel is working. Similarly, by comparing signals of a receiving channel with the size of noise envelope, the echo and feedback control module determines whether the receiving channel is working.

In a case of that the hand-free phone is in use, the echo and feedback control module increases a gain of the sending channel and reduces a gain of the receiving channel when it has determined that the sending channel is working (that is, a local user is speaking to a remote user), and this is equal to turning off a loudspeaker. On the other hand, it increases the gain of the receiving channel and reduces the gain of the sending channel when it has determined that the receiving channel is working (that is, the remote user is speaking to the local user), and this is equal to turning off the microphone. Moreover, if it has determined that both the receiving channel and the sending channel are not working, it will consider that a circuit is idle, and thus reduces the gains of the sending and receiving channels to a fixed value.

The drawback of the aforementioned method, however, is that it is only applicable for analog communication systems because it establishes half duplex calls and controls an echo through hardware. In digital communication systems, all speech signals must be sampled, quantified and coded into digital code streams. The hardware-based echo cancel will increase an error of sample and quantification. In addition, a prominent advantage of digital communication is easy modification, upgrade and integration. The hardware judgment controller used in the aforementioned method overshadows this advantage and causes a significant waste in the hardware. Therefore, the method is not a best choice of hand-free calls in the digital communication systems.

### SUMMARY OF THE INVENTION

The primary object of the present invention is to provide a device, method and system for implementing an echo control on hand-free phones so as to effectively eliminate the echo in digital hand free communication systems.

Accordingly, the present invention is composed of:
1. A device used to implement the echo control on hand-free phones, including an echo eliminator which contains a speech signal detector for sampling local speech signals on a sending channel as well as remote speech signals on a receiving channel, determining call status of a current network based on energy of the obtained remote and local speech signals samples, and transferring the call status to a half duplex controller which controls the echo in the speech signals traveling through the sending channel according to the call status from the speech signals detector; whereas the aforementioned speech signal detector being provided with a sample module that receives and samples the remote and local speech signals, and a call status judgment module such that if an estimated short-time energy value of a current sample point of the local speech signals obtained by the sample module is greater than a defined multiple of a maximum value of the estimated short-time energy value of the remote speech signals in the specified period of time, the module will consider that the local user is speaking, otherwise, the module will consider that the remote user is speaking; and the aforementioned half duplex controller being provided with a half duplex control module which receives the call status of the current network from the speech signal detector, and starts up a speech output module when the local user is speaking or a mute processing module when the remote user is speaking, a speech output module which outputs the speech signals traveling through the sending channel on an “as it is” basis, and the mute processing module which mutes and outputs the speech signals traveling through the sending channel, with the aforementioned devices being applicable to the digital hand-free phones.
2. A way to implement the echo control on the hand-free phones, including:
   Step a: Sampling the local speech signals on the sending channel as well as the remote speech signals on the receiving channel, and determining the call status of the current network based on the energy of the obtained remote and local speech signals samples, including more specifically, receiving the local and remote speech signals and sampling them in the specified period of time, and considering that the local user is talking, if the estimated short-time energy value of the current sample point of the mentioned local speech signals obtained by the sample module is greater than the defined multiple of the maximum value of the estimated short-time energy value of the remote speech signals in the specified period of time; otherwise, considering that the remote user is speaking; Step b: Controlling the echo in the speech signals traveling through the sending channel according to the resulting call status, including more specifically, outputting the speech signals traveling through the sending channel on an “as it is” basis when the local user is speaking, and muting and outputting the speech signals traveling through the sending channel when the remote user is speaking; with the aforementioned method being well-suited for the digital hand-free phones.
3. A digital hand-free phone system which includes a speech compression/decompression module, an echo eliminator, a CODEC chip, a loudspeaker and a microphone, with the echo eliminator, being deployed between the speech compression/decompression module and CODEC chip, for example, determining the call status of the current network, and then controlling the echo in the speech signals traveling through the sending channel according to the resulting call status.

The procedure of controlling the echo in the speech signals traveling through the sending channel according to the resulting call status includes:
(1)The microphone collects the remote speech signals traveling through the sending channel. Then the CODEC chip samples, quantifies and encodes the remote speech signals, produces the digital code stream of the speech signals samples, and inputs it into the echo eliminator with the code stream of the local speech signals samples on the receiving channel.
(2) The echo eliminator outputs the received digital code streams to the speech compression/decompression module without any modification, if the local user is talking. Otherwise, it mutes the received digital code streams before outputting it to the speech compression/decompression module.

Accordingly, the present invention determines the call status of the current network by deploying the echo eliminator in the hand-free phones and eliminates the echo in the sending channel through software. Therefore, the echo in the digital hand-free communication systems is eliminated effectively, user hearing experience is improved and communication quality is guaranteed.

With the software-based half duplex mechanism, the present invention can be applied to various analog or digital voice communication systems for its simplicity, low cost, and ease of debugging and integration.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of principle for a solution using an automatic, half duplex technology in a prior art.

FIG. 2 shows a structural diagram of an embodiment of an echo eliminator according to the present invention.

FIG. 3 shows a flow diagram of an embodiment of the present invention that implements an echo control on digital hand-free phones.

FIG. 4 shows a structural diagram of an embodiment of the present invention that implements a digital hand-free phone system.

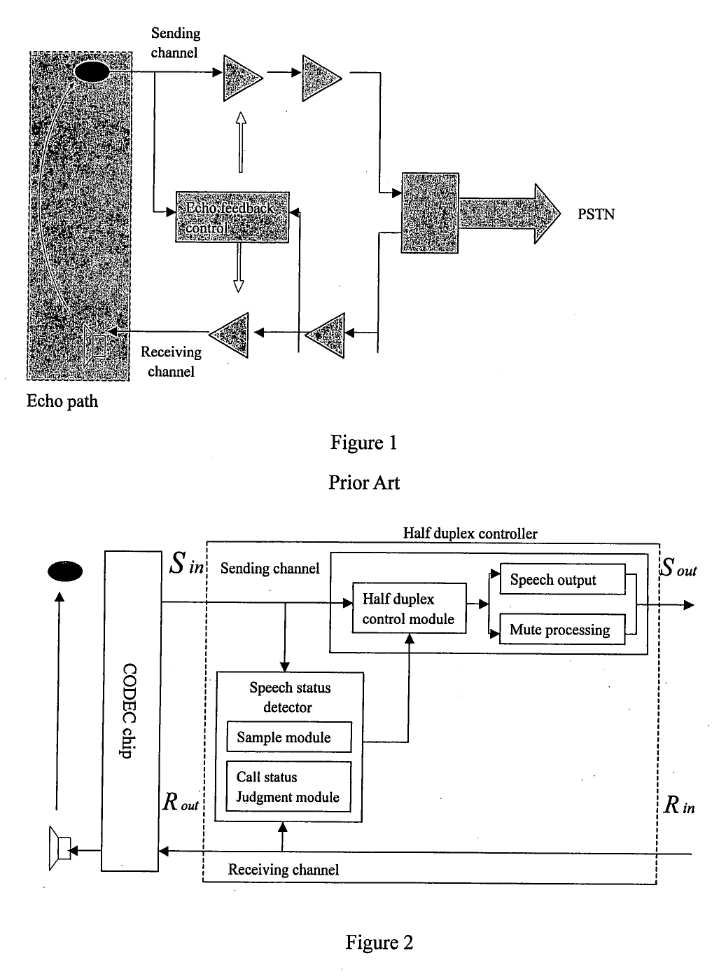

### DETAILED DESCRIPTION OF THE PREFERRED EMBODIMENTS

The present invention provides a device, method and system for implementing an echo control on hand-free phones. The primary technological advantage of the present invention is that it deploys an echo canceller in the hand-free phones, determines a call status of a current network through the echo canceller, and cancels the echo in a sending channel through software.

In the present invention, a speech signal on a receiving channel is referred to as a remote speech signal Rᵢₙ and a speech signal on a sending channel is a local speech signal Sᵢₙ. The remote speech signal is played by a loudspeaker and fed into a microphone to produce an echo, which is then overlapped with the local signal to generate a local speech signal with the echo Sᵢₙ.

In the present invention, a call status of a current network falls into two modes, a remote mode and a local mode. In the remote mode, a remote user of a local hand-free phone is speaking; whereas, in the local mode, a user of the local hand-free phone is speaking.

The following presents a detailed description of the present invention in conjunction with attached drawings. The device described in this method is an echo eliminator, which is used to determine the call status of the current network, and cancel an unnecessary echo in the local speech signal Sᵢₙ through software. As shown in FIG. 2, the echo eliminator includes a speech signal detector and a half duplex controller.

The speech signal detector receives, samples the aforementioned local and remote speech signals, and determines whether the call status of the current network is the remote mode or local mode based on a relationship between estimated short-time energy values of the local speech signal and the remote speech signal obtained through sampling, and transfers the resulting call status to the half duplex controller. The speech signal detector is composed of two modules, a sample module and a call status judgment module.

The sample module receives the local and remote speech signals, and samples them in a specified period of time. If the estimated short-time energy value of a current sample point of the local speech signal obtained by the sample module is greater than a defined multiple of a maximum of the estimated short-time energy value of the remote speech signal in the specified period of time, the call status judgment module will consider the call status to be local mode; otherwise, it considers the call status to be remote mode.

The half duplex controller implements a corresponding half duplex echo control measure in the aforementioned local speech signal with the echo Sᵢₙ, according to the call status of the current network from the speech signal detector. If the call status is the local mode, the half duplex controller will output speech sample points on an “as it is” basis without restraining the echo in the local speech signal Sᵢₙ. On the other hand, if the call status is the remote mode, it restrains, or mutes, the echo in the local speech signal Sᵢₙ. The half duplex controller includes three modules, a half duplex control module, a speech output module and a mute processing module.

The half duplex control module receives the call status of the current network from the speech signal detector, and starts up the speech output module when the local user is speaking (namely, local mode) or the mute processing module when the remote user is talking (namely, remote mode).

The speech output module outputs the speech signals traveling through the aforementioned sending channel on an “as it is” basis.

The mute processing module mutes and outputs the speech signals traveling through the previously mentioned sending channel.

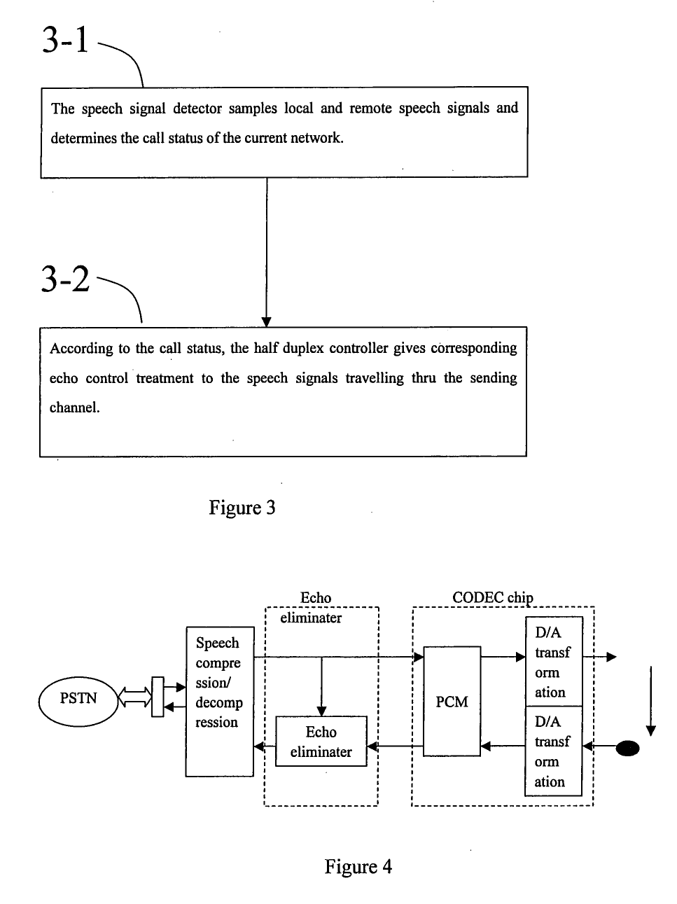

FIG. 3 illustrates the procedure of implementing an echo control on digital hand-free phones as follows:

Step 3-1: The speech signal detector samples the local and remote speech signals and determines the call status of the current network.

The speech signal detector first samples the inputted remote and local speech signals, and determines the call status of the current network depending on the estimated short-time energy values of the speech samples on the sending and receiving channels.

If the estimated short-time energy value of the current sample point on the sending channel is greater than a fixed multiple of the maximum of the estimated short-time energy values of the speech sample point on the receiving channel in the specified period of time, the speech signal detector will consider the call status to be local mode, that is, the user of the local hand-free phone is speaking. Otherwise, it considers the call status to be remote mode, that is, the remote user of the local hand-free phone is speaking; here requiring an echo cancel because the echo occurs on the sending channel.

The formula of the aforementioned judgment is:

$$\vert s ( \hat{n} ) \vert > \frac{1}{2} * max \{ \vert r ( \hat{n} ) \vert , \vert r ( \hat{n} - 1 ) \vert , … \vert r ( \hat{n} - N + 1 ) \vert \} \qquad ( Formula 1 )$$

In Formula 1, s(n) is a sample value of the local speech sample point, ŝ(n)=(1−α)*ŝ(n−1)+α*s(n) is an estimated short-time energy value of the local speech signal sample point, r(n) is a sample value of the remote speech sample point, and \hat{r}(n)=(1−α)*\hat{r}(n−1)+α*r(n) is an estimated short-time energy value of the remote speech signal sample; whereas, α= 1/32 is an estimated short-time energy coefficient used to calculate an estimated short-time energy value of 4 ms delay, N is a predefined constant determined by an echo delay δ (ms), namely, N=8*δ, also referring to the sample number of echo delay. For example, if the echo delay is 30 ms, then N=30*8=240.

If Formula 1 is satisfied, the speech signal detector will consider the call status of the current network to be local mode. Otherwise, it considers the call status to be remote mode. Then it will transfer the resulting call status to the half duplex controller.

Step 3-2: According to the call status of the current network, the half duplex controller gives a corresponding echo control treatment to the speech signals on the sending channel.

Upon receiving the call status from the speech signal detector, the half duplex controller will take corresponding actions. If the call status is in the local mode, it stops the echo and outputs the received local speech signal as the output value Sₒᵤₜ on an “as it is” basis. This is equal to turning on the local microphone.

If the call status is in the remote mode, the half duplex controller cancels the echo in the received local speech signal. It controls the inputted local speech signal Sᵢₙ, and replaces the value Sᵢₙ with 0 as the output value Sₒᵤₜ, that is, it mutes the local speech signal Sᵢₙ. This is equal to the “software mute” of the local microphone, or turning off the microphone. In this way, the remote user cannot hear the echo fed back from the local microphone. After the remote user stops speaking and the local users begins to speak, the local microphone is turned on and the speech signals are sampled and sent to a peer for the purpose of restraining echo feedback and eliminating echo on the hand-free phones.

The aforementioned devices and methods apply to the digital hand-free phones.

FIG. 4 shows an embodiment of the digital hand free phone system described in the present invention, including a speech compression/decompression module, an echo eliminator, a CODEC chip, a loudspeaker, and a microphone, wherein the echo eliminator is deployed between the speech codec and codec chip.

The principle of the digital hand free phone system is described as follows.

On the sending channel, when the local user is speaking, the CODEC chip samples, quantifies and encodes the local and remote speech signals collected by the microphone, generates digital code streams and transfers them to the echo eliminator. The echo eliminator samples the received digital code streams and considers the call status of the current network to be local mode. Therefore, it outputs the digital code streams without any change to the speech compression/decompression module. Next, the compression/decompression module compresses them in speech frames and transmits the frames to the remote user through a PSTN network.

On the sending channel, when the remote user is speaking, the CODEC chip samples, quantifies and encodes the local and remote speech signals collected by the microphone, generates digital code streams and transfers them to the echo eliminator. The echo eliminator samples the received digital code streams and considers the call status of the current network to be remote mode. Therefore, it mutes the digital code streams.

On the receiving channel, the speech compression/decompression module decompresses the speech frames from a peer, generates digital code streams and transmits them to the CODEC chip. Then, the CODEC chip transforms the digital code streams into analog electric signals and plays the analog electric signals through the loudspeaker.

An embodiment of the method described in the present invention is also available. The software procedure in this embodiment includes:
1. Resets a half duplex control register and makes a call.
2. Based on a frame length specified by an employed speech compression algorithm, the speech signal detector puts the remote speech signal collected by the microphone into a large buffer with a length of N plus the frame length. The following takes G.723.1 and a frame length of 30 ms as an example to describe detailed steps. Before processing the speech signal samples for the first time, the speech signal detector needs to wait until the remote speech signal samples are fully filled into the buffer. The samples in the buffer from left to right are x₀ . . . x_{N+239}, and the half duplex control register is located in the header of the buffer and its content is X₀ . . . x₂₃₉.
3. The speech signal detector reads the sample value (Sᵢₙ(i)) of the local speech signal from the input signal of the microphone, and then calculates the estimated short-time energy value P_{Sin}(i)=(1−α)*P_{Sin}(i−1)+α*Sin(i−1) of Sᵢₙ(i) , and the maximum value max(abs(P_{Rin})), P_{Rin}(i)=(1−α)*P_{Rin}(i−1)+α*Rin(i−1) of the estimated short-time energy value P_{Rin} of x₁ . . . x₂₄₀.
4. Sets Sₒᵤₜ=Sᵢₙ(i).
5. If P_{Sin}>½* max (abs(P_{Rin})), the call status of the current network is considered to be local mode and step 7 is executed. Otherwise, the call status is considered to remote mode and step 6 is executed.
6. Sets Sₒᵤₜ=Sₒᵤₜ*0, that is, the muted Sₒᵤₜ serves as the output value of the echo eliminator.
7. Outputs Sₒᵤₜ as the output value of the echo eliminator without any change.
8. Updates the content of the half duplex control register by adding one to a base pointer of the half duplex control register (namely, moving it to right by 1 bit). At this point, the content of the register is x₂ . . . x₂₄₀.
9. Repeats step 3 through step 8 till a frame of data on the left side of the buffer is processed. Here the half duplex control register will be moved to the 240 to 479 bits of the buffer, and it needs to be moved to left by 240 bits to the header of the buffer to reset the base pointer.
10. Reads a frame of new samples and fills it in the 240 to 479 bits of the buffer. Now a frame of samples is processed completely, and speech signal samples can be processed continuously in a next 30 ms period by repeating this process.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A device used for controlling an echo in hand-free phones, including an echo eliminator which is composed of a speech detector for sampling local speech signals on a sending channel as well as remote speech signals on a receiving channel, determining information about call status of a current network based on energy of the obtained remote and local speech signal samples, and transferring the information about the call status to a half duplex controller; and a half duplex controller for controlling an echo in the speech signals traveling through the sending channel according to the call status from the speech signals detector.

2. The speech signal detector according to claim 1, including a sample module which receives and samples the aforementioned remote and local speech signals, and a call status judgment module which determines that a local user is talking when an estimated short-time energy value of a sample point of the local speech signals obtained by the sample module is greater than a defined multiple of a maximum value of the estimated short-time energy value of the remote speech signals in the specified period of time, or a remote user is talking, otherwise.

3. The half duplex controller according to claim 1, including a half duplex control module which receives the call status of the current network from the speech signal detector, and starts up a speech output module when the local user is talking or a mute processing module when the remote user is talking, the speech output module which outputs the speech signals traveling through the sending channel on an “as it is” basis, and the mute processing module which mutes and outputs the speech signals traveling through the sending channel.

4. The half duplex controller according to claim 2, including a half duplex control module which receives the call status of the current network from the speech signal detector, and starts up a speech output module when the local user is talking or a mute processing module when the remote user is talking, the speech output module which outputs the speech signals traveling through the sending channel on an “as it is” basis, and the mute processing module which mutes and outputs the speech signals traveling through the sending channel.

5. The device as described in claim 1, which is suitable for digital hand-free phones.

6. The device as described in claim 2, which is suitable for digital hand-free phones.

7. Away to control an echo in hand-free phones specifically by:
step a: sampling the local speech signals on the sending channel as well as the remote speech signals on the receiving channel, and determining the call status of the current network based on the energy of the obtained remote and local speech signals samples; and step b: controlling the echo in the speech signals traveling through the sending channel according to the resulting call status.

8. The step a according to claim 7, which more specifically includes:
a1: receiving the local and remote speech signals and sampling them in the specified period of time; and
a2: determining that the local user is talking when the estimated short-time energy value of the current sample point of the local speech signals obtained by the sample module is greater than the defined multiple of the maximum value of the estimated short-time energy value of the remote speech signals in the specified period of time, or the remote user is talking, otherwise.

9. The step b in claim 7, which more specifically includes:
b1: outputting the speech signals traveling through the sending channel on an “as it is” basis when the local user is speaking; and
b2: muting and outputting the speech signals traveling through the b sending channel when the remote user is speaking.

10. The step b in claim 8, which more specifically includes:
b1: outputting the speech signals traveling through the sending channel on an “as it is” basis when the local user is speaking; and
b2: muting and outputting the speech signals traveling through the p sending channel when the remote user is speaking.

11. The method according to claim 9, which is suitable for digital hand-free phones.

12. A digital hand-free phone system, including a speech compression and decompression module, an echo eliminator, a CODEC (Coder-Decoder) chip, a loudspeaker and a microphone, wherein the echo eliminator is deployed between the speech compression and decompression module and CODEC chip for determining the call status of the current network, and exercising an echo control to the speech signals traveling through the sending channel according to the resulting call status.

13. The digital hand-free phone system according to claim 12, which is provided with a procedure to control the echo in the speech signals traveling through the sending channel according to the call status comprising:
a) the microphone collecting the remote speech signals traveling through the sending channel, then the CODEC chip sampling, quantifying and encoding the remote speech signals, producing the digital code stream of the speech signals samples, and inputting the code stream into the echo eliminator with the code stream of the local speech signals samples on the receiving channel; and
b) if the local user is talking, the echo eliminator outputting the received digital code streams to the speech compression and decompression module without any modification; otherwise, muting the received digital code streams before outputting the code streams to the speech compression and decompression module.
